(19) United States
(12) Patent Application Publication
(10) Pub. No.: US 2017/0283237 A1
(43) Pub. Date: Oct. 5, 2017

(54) Quick Connect Connection for Handles for Faucets

(71) Applicant: Lonnie Pound, Sherman, NY (US)

(72) Inventor: Lonnie Pound, Sherman, NY (US)

(21) Appl. No.: 15/478,180

(22) Filed: Apr. 3, 2017

Related U.S. Application Data
(60) Provisional application No. 62/316,808, filed on Apr. 1, 2016.

(51) Int. Cl. B67D 1/14; F16K 31/60

(52) U.S. Cl. CPC B67D 1/1477; F16K 31/602

(57) ABSTRACT

A handle mounting assembly for a faucet comprises a quick connect coupling and an adapter. The quick connect coupling has a female threaded end and a female coupling end. The female threaded end fits on the handle mount of a faucet. The adapter has a male coupling end and a male threaded end. The male coupling end is mountable to the female coupling end of the quick connect coupling. The male threaded end is sized to accept the female end of a faucet handle.

### BACKGROUND

Faucets are used to dispense beer from kegs, taps, lines, etc. into a receptacle of some sort. The faucet is sometimes called a “tap” or “spigot”. Faucets are generally ubiquitous in bars and with hobby beer making and other uses. Faucets have handles that are often decorated with the name of the beer to which faucet is connected to provide a visual indication of what is dispensed at the faucet. Sometimes the decoration is simply a name or a logo along the length of the handle. Sometimes the handles are crafted to be complex decorative works of art that are intended to be eye-catching for customers. Decorated handles must be replaced with new handles to identify new beers in the line. This can become burdensome and time consuming especially with facilities that have numerous handles that must be frequently changed. Handles have been known to become stuck or have broken due to over tightening of handles onto the levers. Handles will often face the wrong direction when tightened completely. Certain tap handles are configured in such ways to represent product beers on tap. For example, Goose Island™ uses a replica of a goose head on the top of the handle for its product. Such decorative handles get in the way of adjacent handles and if you must change out one handle, you sometimes must remove adjacent handles to get to the handle you need to remove. This makes the process of changing out handles very time consuming.

### SUMMARY

What is presented is a handle mounting assembly for a faucet that comprises a quick connect coupling and an adapter. The quick connect coupling has a female threaded end and a female coupling end. The female threaded end fits on the handle mount of a faucet. The adapter has a male coupling end and a male threaded end. The male coupling end is mountable to the female coupling end of the quick connect coupling. The male threaded end is sized to accept the female end of a faucet handle.

Those skilled in the art will realize that this invention is capable of embodiments that are different from those shown and that details of the apparatus and methods can be changed in various manners without departing from the scope of this invention. Accordingly, the drawings and descriptions are to be regarded as including such equivalent embodiments as do not depart from the spirit and scope of this invention.

### BRIEF DESCRIPTION OF DRAWINGS

For a more complete understanding and appreciation of this invention, and its many advantages, reference will be made to the following detailed description taken in conjunction with the accompanying drawings.

FIG. 1 shows one embodiment of a handle mounting assembly connected to a faucet and a handle;

FIG. 2 is an exploded view side view showing how the components of the handle mounting assembly of FIG. 1 are connected to a handle; and

FIG. 3 is a perspective view of the exploded view of FIG. 2.

### DETAILED DESCRIPTION

Referring to the drawings, it will be understood that variations in the embodiments can generally be interchanged without deviating from the invention.

Faucets are used to dispense beer from kegs, taps, lines, etc. into a receptacle of some sort. The faucet is sometimes called a “tap” or “spigot”. Faucets are generally ubiquitous in bars and with hobby beer making and other uses. A standard faucet comprises a connection point to a fluid line and a shaft that is moved by a lever that turns on and off the flow of fluid through the faucet. The lever typically has a handle mount that is a male threaded end to receive a handle that assists in the manipulation of the lever. The lever may also add decorative and aesthetic appeal to the faucet.

Handles are often decorated with the name of the beer to which the faucet is connected to provide a visual indication of what is dispensed at the faucet. Sometimes the decoration is simply a name or a logo along the length of the handle. Decorated handles must be replaced with new handles to identify new beers in the line. This can become burdensome and time consuming especially with facilities that have numerous handles that must be frequently changed. Handles have been known to become stuck or have broken due to over tightening of handles onto the levers.

Handles will often face the wrong direction when tightened completely and would hide the logo or the decoration from the user or the customer. Sometimes the handles are crafted to be complex decorative works of art that are intended to be eye-catching for customers. Certain tap handles are configured in such ways to represent product beers on tap. For example, Goose Island uses a replica of a goose head on the top of the handle for its product. Such decorative handles get in the way of adjacent handles and if you must change out one handle, you sometimes must remove adjacent handles to get to the handle you need to remove. This makes the process of changing out handles very time consuming.

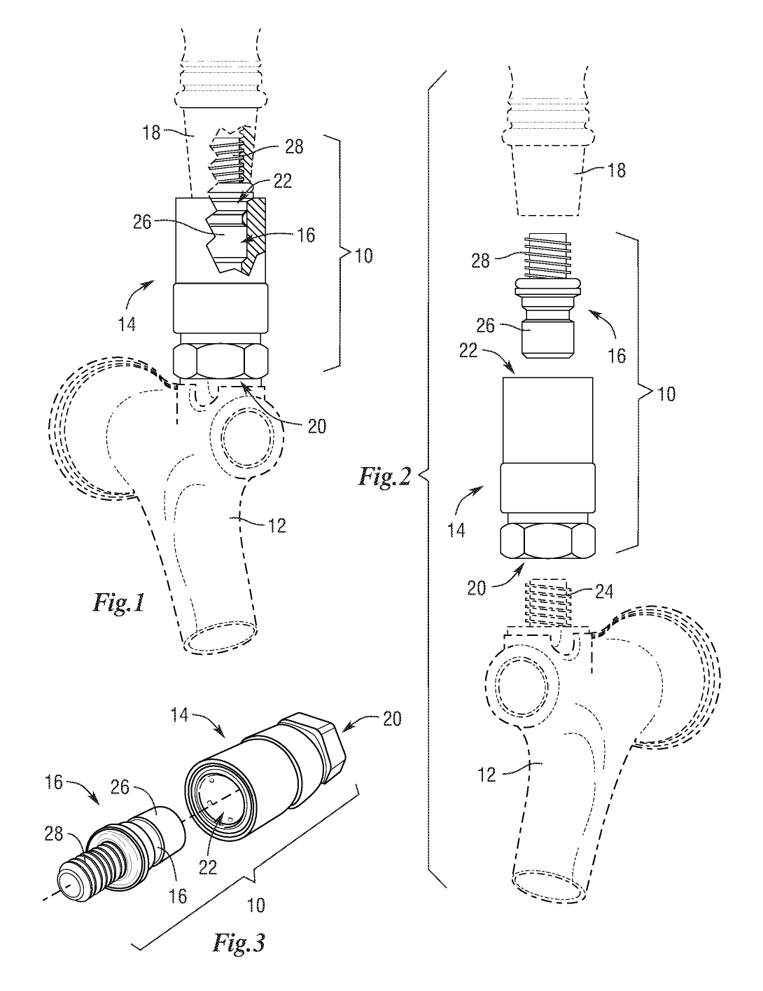

As best understood by looking at FIGS. 1-3, what is presented is a handle mounting assembly 10 for a faucet 12 that comprises a quick connect coupling 14 and an adapter 16 interposed between the faucet 12 and the handle 18. The quick connect coupling 14 has a female threaded end 20 and a female coupling end 22. The female threaded end 20 fits on the handle mount 24 of the faucet 12.

The adapter 16 has a male coupling end 26 and a male threaded end 28. The male coupling end 26 is mountable to the female coupling end 22 of the quick connect coupling 14. The male threaded end 28 is sized to accept the female end of a handle 30.

Installation of the handle mounting assembly 10 is a simple matter—the quick connect coupling 14 is screwed onto the handle mount 24 of the faucet 12 which typically has a ⅜″ outer diameter thread, although some have threads of other dimensions. Most handles 30 come with standard sized female openings to fit on the handle mounts 24 of most faucets 12 and therefore are typically a corresponding ⅜″ inner diameter, but there are some variations for those faucets 12 that may be of other dimensions. The quick connect coupling 14 is a fitting that allows the connection and disconnection of an attachment without the use of tools. Such couplings are labor saving devices that are used for many purposes but have not been used for the purpose described herein. The quick connect coupling 14 is of a standard design and any other coupling mechanism that performs the same function may be substituted. The handle mounting assembly 10 is made out of material that is durable to withstand long use and resistant to rust and other degradation. Metals, plastics, or other materials may be used.

Each handle 30 is mounted to an adapter 16 which can be left on the handle 30 so that when the time comes to change the handle, all that has to be done is disconnect the handle/adapter combination from the quick connect coupling 14 and replace the handle with another handle/adapter. This reduces the time required to replace the handles and allows it to be done without any additional equipment. As the handle 30 is not screwed onto the faucet 12, there is no risk over overtightening and damaging the handle mount 24 or needing a tool to loosen an over-tightened handle 20. The goal is to use all of the existing equipment in the system so that the end user doesn't have to make any other changes other than to insert this handle mounting assembly 10 between the faucet 12 and the handle 30.

Quick connect couplings 14 as shown typically allow free rotation of the adapter 16. This allows the rotation of the handle 30 relative to the handle mount 24. This allows the user to align the handles 30 to maximize customer sight of the decorations and advertising on the handle 30 itself. This also prevents the user from to overtightening or under-securing the handle on handle mount in order to properly align the handle with a customer's line-of-sight. This reduces damage to the faucet and reduces the downtime for replacing damaged spigots.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

What is claimed is:

1. A handle mounting assembly for a faucet that comprises
a quick connect coupling have a female threaded end and a female coupling end, said female threaded end fits on the handle mount of a faucet; and
an adapter having a male coupling end and a male threaded end, said male coupling end is mountable to said female coupling end of said quick connect coupling, and said male threaded end is sized to accept the female end of a faucet handle.

2. An adapter for a faucet handle that comprises:
a male coupling end and a male threaded end;
said male coupling end is mountable to the female coupling end of a quick connect coupling;
and said male threaded end is sized to accept the female end of a faucet handle

3. A quick connect coupling for a faucet comprising:
a female threaded end and a female coupling end;
said female threaded end fits on the handle mount of a faucet; and
said female coupling end is configured to receive the male coupling end of an adapter for a faucet handle.
